(19) United States
(12) Patent Application Publication
(10) Pub. No.: US 2007/0072989 A1
(43) Pub. Date: Mar. 29, 2007

(54) Two-part sizing composition for reinforcement fibers

(76) Inventors: Willy H. Piret, Xhendelesse (BE); Nadia Masson, Olne (BE)

Correspondence Address: OWENS CORNING, 2790 COLUMBUS ROAD, GRANVILLE, OH, 43023, US

(21) Appl. No.: 11/522,586

(22) Filed: Sep. 18, 2006

Related U.S. Application Data
(63) Continuation-in-part of application No. 10/804,623, filed on Mar. 19, 2004, now Pat. No. 7,129,289.

(51) Int. Cl. B60C 1/00

(52) U.S. Cl. 524/571; 524/562; 524/556; 428/388; 428/380; 428/383; 428/378; 65/443; 65/444; 65/447; 65/448

(57) ABSTRACT

A two-part sizing formulation that imparts improved strength of reinforced composites including a size composition and a binder composition is provided. The size composition may include one or more coupling agents and one or more film forming agents. The binder composition includes a blocked isocyanate and a copolymer formed of a maleic anhydride and at least one other monomer copolymerizable therewith. In a preferred embodiment, the binder composition includes an ethylene-maleic acid copolymer formed by the hydrolysis of an ethylene-maleic anhydride copolymer. In an alternate embodiment, the size composition includes a coupling agent, a lubricant, and a wetting agent. The size composition may be applied to a reinforcing fiber material before the binder size material is applied. The two-part size composition may be applied to a reinforcing fiber which may then be densified or compacted to form a densified reinforcing fiber product, such as a pellet.

### CROSS REFERENCE TO RELATED APPLICATIONS

This application is a continuation-in-part of U.S. patent application Ser. No. 10/804,623 entitled “Hydrolyzation Resistant Sizing Composition” filed Mar. 19, 2004, the entire content of which is expressly incorporated herein by reference.

### TECHNICAL FIELD AND INDUSTRIAL APPLICABILITY OF THE INVENTION

The present invention relates generally to a sizing composition for a reinforcing fiber material, and more particularly, to a two-part sizing formulation that imparts improved fiber dispersion to reinforced composites. The two-part sizing composition includes a size composition and a binder composition. A composite article formed from a reinforcing fiber material sized with a two-part sizing formulation is also provided.

### BACKGROUND OF THE INVENTION

Glass fibers are useful in a variety of technologies. For example, glass fibers are commonly used as reinforcements in polymer matrices to form glass fiber reinforced plastics or composites. Glass fibers have been used in the form of continuous or chopped filaments, strands, rovings, woven fabrics, nonwoven fabrics, meshes, and scrims to reinforce polymers. It is known in the art that glass fiber reinforced polymer composites possess higher mechanical properties compared to unreinforced polymer composites, provided that the reinforcement fiber surface is suitably modified by a sizing composition. Thus, better dimensional stability, tensile strength and modulus, flexural strength and modulus, impact resistance, and creep resistance may be achieved with glass fiber reinforced composites.

Chopped glass fibers are commonly used as reinforcement materials in reinforced composites. Conventionally, glass fibers are formed by attenuating streams of a molten glass material from a bushing or orifice. The glass fibers may be attenuated by a winder that collects gathered filaments into a package or by rollers that pull the fibers before they are collected and chopped. An aqueous sizing composition, or chemical treatment, is typically applied to the fibers after they are drawn from the bushing. After the fibers are treated with the aqueous sizing composition, they may be dried in a package or chopped strand form.

Chopped strand segments may be mixed with a polymeric resin and supplied to a compression- or injection- molding machine to be formed into glass fiber reinforced composites. Typically, the chopped strand segments are mixed with pellets of a thermoplastic polymer resin in an extruder. In one conventional method, polymer pellets are fed into a first port of a twin screw extruder and the chopped glass fibers are fed into a second port of the extruder with the melted polymer to form a fiber/resin mixture. Alternatively, the polymer pellets and chopped strand segments are dry mixed and fed together into a single screw extruder where the resin is melted, the integrity of the glass fiber strands is destroyed, and the fiber strands are dispersed throughout the molten resin to form a fiber/resin mixture. Next, the fiber/resin mixture is degassed and formed into pellets. These dry fiber strand/resin dispersion pellets are then fed to a molding machine and formed into molded composite articles that have a substantially homogeneous dispersion of glass fiber strands throughout the composite article.

Unfortunately, chopped glass fibers are often bulky and do not flow well in automated equipment. As a result, the chopped fiber strands may be compacted into rod-shaped bundles or pellets to improve their flowability and to enable the use of automated equipment, such as, for example, for transporting the pellets and mixing the pellets with the polymer resins. U.S. Pat. No. 5,578,535 to Hill et al. discloses glass fiber pellets that are from about 20% to 30% denser than the individual glass strands from which they are made, and approximately 5 to 15 times larger in diameter. These pellets are prepared by hydrating cut fiber strand segments to a hydration level sufficient to prevent separation of the fiber strand segments into individual filaments but insufficient to cause the fiber strand segments to agglomerate into a clump. The hydrated strand segments are then mixed for a period of time sufficient for the strand segments to form pellets. Suitable mixing methods include processes that keep the fibers moving over and around one another, such as by tumbling, agitating, blending, commingling, stirring and/or intermingling the fibers.

Sizing compositions, such as are used in reinforced composites, are well-known in the art and conventionally include a polyacid polymeric component, a film forming polymeric component, a coupling agent, and a lubricant. A polyacid sizing composition is typically added to glass fibers to reduce interfilament abrasion and to make the glass fibers compatible with the polymeric matrices they are intended to reinforce. The sizing composition also ensures the integrity of the strands of glass fibers, e.g., the interconnection of the glass filaments that form the strand.

One fundamental problem associated with polyacid conventional sizing compositions used in reinforced composites is the inability to evenly disperse the glass fibers in a melted polymeric resin. Uneven dispersion of the glass fibers in the resin results in a product that may have a reduction in strength due to the uneven dispersement of the glass fibers. Another problem associated with conventional sizing compositions used in reinforced composites is the aging of the polymer matrix composite under the action of hydrolysis, which results in a reduction of mechanical strength. For example, polyamide composites reinforced with conventional sizing compositions often demonstrate a reduction in impact strengths (e.g., Charpy or Izod, un-notched or notched) as well as a reduction in tensile strength and elongation at break when such tests are run on hydro-aged composite pieces.

Another problem commonly known to pellets made from fiber strands that are made for use as reinforcements in composites and other fiber-reinforced products is the discoloration they could cause to the thermoplastic during compounding and/or heat aging of the molded part. This discoloration is typically seen as an undesirable yellowing of the thermoplastic that is thought to be related to some of the materials used to size the fiber strands, including, but not limited to, the binders and film formers used in the sizing compositions used to treat the fiber strands.

Discoloration in molded composite products, or in the materials used to manufacture molded composite products, may arise from the presence of contaminants in one or more materials that make up the composite formulation, or from the presence of impurities in the ingredients that are used to form fiber-reinforced composites. These ingredients may be materials used in sizing compositions for coating reinforcing fibers before they are molded into composites. For example, conventional sizing compositions often impart a yellow color or other discoloration to the compounds when such sizings are applied. These discolorations may be carried into the composite product when the reinforcements are molded. These discolorations may be caused by oxidatative decomposition of unsaturated chemicals, such as fatty unsaturated surfactants and/or lubricants, which are of low thermal stability. These discolorations may also be caused by nitrogen containing compounds, such as amides, imides, cationic surfactants or amine-based chemicals, which are used, for example, as neutralizing agents.

Thus, there exists a need in the art for a cost-effective sizing composition that has excellent fiber dispersion, that confers improved hydrolysis resistance to reinforced composites under extreme hydrolysis conditions, possesses improved mechanical properties to the final composite part, is inconsequentially affected by calcium stearate, and has little or no coloration in the reinforced composite.

### SUMMARY OF THE INVENTION

It is an object of the present invention to provide a two-part sizing formulation that includes a (1) size composition that contains a silane coupling agent and a film-forming agent and (2) a binder composition that contains at least one blocked isocyanate and a copolymer or a derivative thereof. The copolymer is preferably formed from maleic anhydride and at least one other monomer copolymerizable therewith. In a preferred embodiment, the binder composition includes a partial ammonium salt of ethylene-maleic acid (EMA) copolymer (e.g., a compound having a polyethylene polymer backbone with pendant polyfunctional groups, each of which contains one or more ammonium salt groups) formed by the hydrolysis of an ethylene-maleic anhydride copolymer. The silane coupling agent is not particularly limited, but is preferably an amino or di-amino silane coupling agent. Polyurethane film formers are a preferred class of film formers for use in the inventive size composition and in the binder composition because poly,urethane film formers demonstrate good compatibility with polyamide matrices and help to improve the dispersion of the glass fiber bundles in the resin melt when forming a composite article. This improved dispersion causes a reduction or elimination of defects in the final article caused by poor dispersion of the reinforcement fibers. Additionally, the two-part sizing formulation of the invention imparts improved fiber dispersion and improved dry-as-molded mechanical properties and hydrolysis resistance to polymer reinforced composites. The precursor size composition is applied to the reinforcing fiber strand before the binder composition is applied. For example, the precursor size composition may be added to a continuous fiber material, the glass fiber strands may be chopped to form chopped strand segments, and the binder composition may be applied to the chopped strand segments. The chopped strand segments may then be densified or compacted to form a densified reinforcing fiber product, such as pellets. The pelletized form of the chopped strand segments permits much easier handling, it is substantially fuzz free, and allows for pneumatic conveying of the pellets. In addition, the densified pellets provide a convenient form for storage and handling of the chopped fibers used as reinforcing materials in composite structures.

It is another object of the present invention to provide an alternate two-part sizing formulation. In this alternative embodiment, the two-part sizing composition includes a first size composition containing one or more coupling agents, one or more lubricants, at least one wetting agent, and optionally, conventional additives such as, but not limited to, pH adjusters, antioxidants, antifoaming agents, processing aids, antistatic agents, and non-ionic surfactants. The copolymer is preferably formed from maleic anhydride and at least one other monomer copolymerizable therewith. In a preferred embodiment, the binder composition includes a partial ammonium salt of ethylene-maleic acid (EMA) copolymer (e.g., a compound having a polyethylene polymer backbone with pendant polyfunctional groups, each of which contains one or more ammonium salt groups) formed by the hydrolysis of an ethylene-maleic anhydride copolymer. The silane coupling agent is not particularly limited, but is preferably an amino or di-amino silane coupling agent. Polyurethane film formers are a preferred class of film formers for use in the first size composition because they demonstrate good compatibility with polyamide matrices and help to improve the dispersion of the glass fiber bundles in the resin melt when forming a composite article. This improved dispersion causes a reduction or elimination of defects in the final article caused by poor dispersion of the reinforcement fibers. Additionally, the two-part sizing formulation of the invention imparts improved fiber dispersion and improved dry-as-molded mechanical properties and hydrolysis resistance to polymer reinforced composites. The precursor size composition is applied to the reinforcing fiber strand before the binder composition is applied. For example, the precursor size composition may be added to a continuous fiber material, the glass fiber strands may be chopped to form chopped strand segments, and the binder composition may be applied to the chopped strand segments. The chopped strand segments may then be densified or compacted to form a densified reinforcing fiber product, such as pellets. The pelletized form of the chopped strand segments permits much easier handling, it is substantially fuzz free, and allows for pneumatic conveying of the pellets. In addition, the densified pellets provide a convenient form for storage and handling of the chopped fibers used as reinforcing materials in composite structures.

It is yet another object of the present invention to provide reinforced composite article that includes a plurality of reinforcing fiber materials sized with a two-part sizing composition that contains (1) a size composition that includes a silane coupling agent and a film-forming agent, and a binder composition that includes at least one blocked isocyanate, and a copolymer or a derivative thereof, said copolymer being formed from maleic anhydride and at least one other monomer copolymerizable therewith. The silane coupling agent, film forming agent, blocked isocyanate, and copolymer are the same as those discussed in the previous paragraphs and will therefore not be discussed in detail here. The two-part sizing formulation of the present invention imparts improved physical properties to composites formed from pellets, such as improved strength under hydrolysis conditions, improved tensile strength, improved tensile elongation at break, and improved Charpy impact strength.

It is an advantage of the present invention that by applying the size composition to a reinforcing fiber material prior to the binder composition, a layer of silane is applied directly and substantially evenly to the reinforcing fiber material prior to the application of a film forming agent. Due to the interaction of the silane with the surface of the reinforcing fiber material, optimal physical properties of the composite product formed from the sized reinforced fiber materials may be achieved. In addition, the presence of silane on the reinforcing fiber material may reduce subsequent chemical corrosion and interfilament abrasion of the fiber material.

It is another advantage of the present invention that polyurethane film formers present in the sizing composition demonstrate good compatibility with polyamide matrices, which helps to improve the dispersion of the reinforcement fiber bundles in the resin melt (e.g., in extrusion process or injection molding process) when forming a composite article. This increased fiber dispersion may cause a reduction of defects such as visual defects in the final product, a reduction in processing breaks, and/or low mechanical properties in the final article.

It is yet another advantage that the present invention imparts improved physical properties such as improved dry-as-molded (DAM) mechanical properties of the composite part or after aging the composite part in severe hydrolysis conditions to composites formed from industrially processable and easily dispersible pellets.

It is also an advantage of the present invention that the two-part sizing formulation has improved stability over conventional sizing formulations that contain an aminosilane and a polyacid in the same mixture.

It is a further advantage of the present invention that using the precursor size composition and the binder composition allows the fibers to be treated directly after forming with a precursor sizing composition that could not otherwise normally be included in the fiber forming process.

It is another advantage of the present invention that the precursor size composition and the binder composition and the process of the present invention facilitate treating reinforcing fibers during a continuous process that includes forming the fibers as well as their subsequent processing or handling.

It is a feature of the present invention that the two-part sizing composition does not result in the development of undesirable off colors or yellowing of the finished product.

The foregoing and other objects, features, and advantages of the invention will appear more fully hereinafter from a consideration of the detailed description that follows.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a graphical illustration of the glass fiber bundle dispersion in Polyamide 66 (30% glass fibers) sized with the inventive size formulation and fiber bundles sized with the closest comparative size formulations;

FIG. 2 is a graphical illustration of the Charpy impact strength of Polyamide 6 with different percentages of calcium stearate reinforced by 30% glass fibers sized with the inventive size formulation and fibers sized with the closest comparative size formulations; and

FIG. 3 is a graphical illustration of the tensile strength of Polyamide 6 with different percentages of calcium stearate reinforced with 30% glass fibers sized with the inventive size formulation and fibers sized with the closest comparative size formulations.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references. The terms “film forming agent” and “film former” may be used interchangeably herein. In addition, the terms “reinforcing fiber material” and “reinforcing fiber” may be used interchangeably herein. Further, the terms “composition” and “formulation” may be used interchangeably herein.

The present invention relates to a two-part sizing formulation that improves fiber dispersion in the polymeric resin used to form reinforced composites. In particular, the two-part sizing formulation of the invention imparts improved fiber dispersion and improved dry-as-molded mechanical properties and hydrolysis resistance to polymer reinforced composites. The two-part sizing formulation includes a precursor size composition and a binder composition. The precursor size composition is applied to the reinforcing fiber strand before the binder composition is applied. For example, the precursor size composition may be added to a continuous fiber material, the glass fiber strands may be chopped to form chopped strand segments, and the binder composition may be applied to the chopped strand segments. The chopped strand segments may then be densified or compacted to form a densified reinforcing fiber product, such as pellets. The pelletized form of the chopped strand segments permits much easier handling, it is substantially fuzz free, and allows for pneumatic conveying of the pellets. In addition, the densified pellets provide a convenient form for storage and handling of the chopped fibers used as reinforcing materials in composite structures.

Typically, the precursor size and the binder composition are used to treat a reinforcing fiber such as a strand, thread, or roving. The reinforcing fiber material may be one or more strands of glass formed by conventional techniques such as by drawing molten glass through a heated bushing to form substantially continuous glass fibers. These fibers may subsequently be collected into a glass strand. Any type of glass, such as A-type glass, C-type glass, E-type glass, S-type glass, ECR-type glass fibers (e.g., Advantex® glass fibers commercially available from Owens Corning), Hypertex, or modifications thereof. Preferably, the reinforcing fiber material is E-type glass or Advantex® glass.

Alternatively, the reinforcing fiber material may be strands of one or more synthetic polymers such as, but not limited to polyester, polyamide, aramid, polyaramid, and mixtures thereof. The polymer strands may be used alone as the reinforcing fiber material, or they can be used in combination with glass strands such as those described above. As a further alternative, carbon or other natural fibers may be used as the reinforcing fiber material. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber material include cotton, jute, bamboo, ramie, bagasse, hemp, coir, linen, kenaf, sisal, flax, henequen, and combinations thereof.

The reinforcing fiber material may include fibers that have a diameter of from about 6 microns to about 24 microns and may be cut into segments approximately 1 mm to about 50 mm in length. Preferably, the fibers have a diameter from about 7 microns to about 14 microns and a length from about 3 mm to about 13 mm. Most preferably, the fibers have a diameter of approximately 10 microns. Prior to the densification of the reinforcing fiber material as described below, each strand may contain from approximately 500 fibers to approximately 8,000 fibers.

After the reinforcing fibers are formed, and prior to their collection into a strand, they may be coated with a first size composition. In one exemplary embodiment of the present invention, the precursor size composition is formed of an aminosilane and a film forming agent. Conventional additives such as, but not limited to, pH adjusters, antioxidants, antifoaming agents, processing aids, antistatic agents, and non-ionic surfactants may optionally be added to the first precursor sizing composition.

The first precursor size composition includes one or more coupling agents. The first precursor size composition may be applied to the fibers with a Loss on Ignition (LOI) of 0.02 to 0.40 on the dried fiber. As used in conjunction with this application LOI may be defined as the percentage of organic solid matter deposited on the glass fiber surfaces. Preferably, the coupling agent is a silane coupling agent. Besides their role of coupling the surface of the reinforcement fibers and the plastic matrix, silanes also function to enhance the adhesion of the polycarboxylic acid component to the reinforcement fibers and to reduce the level of fuzz, or broken fiber filaments, during subsequent processing. Examples of silane coupling agents that may be used in the present first precursor size composition may be characterized by the functional groups amino, epoxy, vinyl, methacryloxy, ureido, isocyanato, and azamido. In preferred embodiments, the silane coupling agents include silanes containing one or more nitrogen atoms that have one or more functional groups such as amine (primary, secondary, tertiary, and quarternary), amino, imino, amido, imido, ureido, isocyanato, or azamido.

Suitable silane coupling agents include, but are not limited to, aminosilanes, silane esters, vinyl silanes, methacryloxy silanes, epoxy silanes, sulfur silanes, ureido silanes, and isocyanato silanes. Specific non-limiting examples of silane coupling agents for use in the instant invention include γ-aminopropyltriethoxysilane (A-1100), n-phenyl-γ-aminopropyltrimethoxysilane (Y-9669), n-trimethoxy-silyl-propyl-ethylene-diamine (A-1120), methyl-trichlorosilane (A-154), γ-chloropropyl-trimethoxy-silane (A-143), vinyl-triacetoxy silane (A-188), methyltrimethoxysilane (A-1630), γ-ureidopropyltrimethoxysilane (A-1524). Other examples of suitable silane coupling agents are set forth in Table 1. All of the silane coupling agents identified above and in Table 1 are available commercially from GE Silicones.

TABLE 1

| Silanes | Label |
|---|---|
| Silane Esters | |
| octyltriethoxysilane | A-137 |
| methyltriethoxysilane | A-162 |
| methyltrimethoxysilane | A-163 |
| Vinyl Silanes | |
| vinyltriethoxysilane | A-151 |
| vinyltrimethoxysilane | A-171 |
| vinyl-tris-(2-methoxyethoxy)silane | A-172 |
| Methacryloxy Silanes | |
| γ-methacryloxypropyl-trimethoxysilane | A-174 |
| Epoxy Silanes | |
| β-(3,4-epoxycyclohexyl)-ethyltrimethoxysilane | A-186 |
| Sulfur Silanes | |
| γ-mercaptopropyltrimethoxysilane | A-189 |
| Amino Silanes | |
| γ-aminopropyltriethoxysilane | A-1101 |
| | A-1102 |
| aminoalkyl silicone | A-1106 |
| γ-aminopropyltrimethoxysilane | A-1110 |
| triaminofunctional silane | A-1130 |
| bis-(γ-trimethoxysilylpropyl)amine | A-1170 |
| polyazamide silylated silane | A-1387 |
| Ureido Silanes | |
| γ-ureidopropyltrialkoxysilane | A-1160 |
| γ-ureidopropyltrimethoxysilane | Y-11542 |
| Isocyanato Silanes | |
| γ-isocyanatopropyltriethoxysilane | A-1310 |

Additional examples of suitable silane coupling agents include the products from Chisso having the trade designations set forth in Table 2.

TABLE 2

| | |
|---|---|
| S-310 | n-(2-aminoethyl)-3-aminopropylmethyldimethoxysilane |
| S-320 | n-(2-aminoethyl)-3-aminopropyltrimethoxysilane |
| S-350 | n-[2-(vinylbenzylamino)ethyl]-3-aminopropyl- |
| | trimethoxysilane monohydrochloride (methanol solution) |
| S-510 | 3-glycidoxypropyltrimethoxysilane |
| S-610 | 3-chloropropylmethydimethoxysilane |
| S-620 | 3-chloropropyltrimethoxysilane |

The silane coupling agents used in the first precursor size composition may be replaced by alternative coupling agents or mixtures. For example, A-1387 may be replaced by a version in which the methanol solvent is replaced by ethanol. A-1126, an aminosilane coupling agent including a mixture of approximately 24% by weight diaminosilane modified by a surfactant in a methanol solution (GE Silicones), may be replaced with trimethoxy-silyl-propyl-ethylene-diamine (Z-6020 from Dow Corning). A-1120 or Z-6020 may be substituted by a pre-hydrolyzed version. Z-6020 may be replaced by Z-6137, a pre-hydrolyzed version lacking the alcohol solvent and including 33% diaminosilane in water at a concentration of 24% solids (commercially available from Dow Corning). In addition, A-1100 may be replaced by its hydrolyzed form Y-9244, which will reduce or eliminate the ethanol emission. Preferably, the silane coupling agent is an aminosilane or a diaminosilane.

In addition, the first precursor size composition may include at least one resinous film forming agent. Film formers are agents which create improved adhesion between the reinforcing fibers, which results in improved strand integrity. In the size composition, the film former acts as a polymeric binding agent to provide additional protection to the reinforcing fibers and improves processability, such as a reduction in fuzz generated by high speed chopping. Suitable film formers include thermosetting and thermoplastic polymers which promote the adhesion of sizing compositions. Polyurethane film formers are a preferred class of film formers for use in the first precursor size composition because they demonstrate good compatibility with polyamide matrices and help to improve the dispersion of the glass fiber bundles in the resin melt (e.g., extrusion process or injection molding process) when forming the composite article, which causes a reduction or elimination of defects in the final article that caused by poor dispersion of the reinforcement fibers (e.g., visual defects, processing breaks, and/or low mechanical properties). The polyurethane dispersions utilized in the first precursor size composition may be part of a dispersion that either is based or is not based on a blocked isocyanate. By utilizing a polyether based polyurethane crosslinking agent, the crosslinking reaction between the film formers changes, which causes the film former to be more compatible with the resin. It is believed that a higher ratio of polyether improves compatibility with the resin.

Examples of suitable urethane film formers that are not based on blocked isocyanates that may be used in the binder composition include, but are not limited to, Baybond® XP-2602 (a non-ionic polyurethane dispersion (Bayer Corp.)); Baybond® PU-401 and Baybond® PU-402 (anionic urethane polymer dispersions (Bayer Corp.)); Baybond® VP-LS-2277 (an anionic/non-ionic urethane polymer dispersion (Bayer Corp.)); Aquathane 518 (a non-ionic polyurethane dispersion (Dainippon, Inc.)); and Witcobond 290H (polyurethane dispersion (Witco Chemical Corp.)). Other examples of suitable film forming agents for use in the binder composition include, but are not limited to, polyvinylpyrrolidone homo- and co-polymers and other polymers bearing amide-like functionality such as polyamide, polyvinylformamide, or polyacrylamide. In at least one exemplary embodiment, the film forming agent is an aqueous polyurethane dispersion that is not part of a dispersion that includes a polyurethane and a blocked isocyanate. Preferred film formers for use in the first precursor size composition include polyether based polyurethanes. It is desirable that the amount of film former present in the two-part sizing formulation is such that the two-part sizing formulation provides the desired level of compatibility for the reinforcement fibers and the polymer matrix to help fiber dispersion during processing to form a composite part without affecting the positive effect of the polyacid moieties to improve dry-as-molded and hydro-aged mechanical properties and without developing static and/or an undesirable color in the reinforcing fiber product. The film forming agent may be present on the reinforcement fibers in an amount sufficient to provide an LOI from 0% to about 1.20%. Preferably, the film forming agent is present on the fibers in an amount sufficient to provide an LOI from about 0.10% to about 0.80%.

Examples of suitable urethane film formers based on blocked isocyanates which may be used in the binder composition include, but are not limited to, Baybond® PU-130 (an anionic/non-ionic urethane polymer dispersion (Bayer Corp.)); Baybond® PU-403 (a polyurethane dispersion (Bayer Corp.)); Baybond® PU-239 (a crosslinkable anionic/non-ionic urethane polymer dispersion (Bayer Corp.)); Witcobond 296BH (an aqueous blocked polyurethane dispersion, available from Baxenden Chemicals); Witcobond 296B (an aqueous blocked polyurethane dispersion, available from Witco); and Baybond® LPFLL1068.

Although the first precursor size composition is effective at any pH level, the pH preferably falls within the range of from 7 to 11. The pH may be adjusted depending on the intended application, or to facilitate the compatibility of the ingredients of the size composition. Any suitable pH adjuster (e.g., a weak organic acid such as acetic acid or a base such as ammonia) may be added to the size composition in an amount sufficient to adjust the pH to a desired level.

The first precursor size composition may be prepared by adding the individual components using any suitable method known to those of skill in the art. In a preferred embodiment, the first precursor size composition may be made by dissolving each of the ingredients into a premix with agitation. The separate premixes may then be combined with deionized water to form a main mixture and to achieve the appropriate concentration and control the mix of solids. The premixes may be added in any order. If necessary, the pH of the main mixture may be adjusted to a desired level. The premixes may be added separately, or they may be added at the same time to form the main mixture.

As an alternative to utilizing the first precursor size composition, a second precursor size composition may be used. A suitable second precursor size composition according invention includes one or more coupling agents, one or more lubricants, at least one wetting agent, and optionally, conventional additives such as, but not limited to, pH adjusters, antioxidants, antifoaming agents, processing aids, antistatic agents, and non-ionic surfactants. The size composition may be applied to the fibers with a Loss on Ignition (LOI) of less than 0.1% on the dried fiber.

The second precursor size composition includes one or more of the above-identified coupling agents. The coupling agent may be applied to the fibers in an amount sufficient to achieve a Loss on Ignition (LOI) of from about 0.02% to about 0.10% on the dried fiber, and preferably in an amount of from about 0.04% to about 0.08%.

In addition, the second precursor size composition may include at least one lubricant to facilitate manufacturing. The lubricant may be present in the second precursor size in an amount sufficient to achieve an LOI from 0 to about 0.01%. Preferably, the lubricant is present in an amount sufficient to achieve an LOI from about 0.0002% to about 0.006%. Any suitable lubricant may be used. Non-limiting examples of lubricants suitable for use in the size composition include water-soluble ethyleneglycol stearates (e.g., polyethyleneglycol monostearate, butoxyethyl stearate, polyethylene glycol monooleate, and butoxyethylstearate), ethyleneglycol oleates, ethoxylated fatty amines, glycerine, emulsified mineral oils, and organopolysiloxane emulsions. Other examples of lubricants include alkyl imidazoline derivatives (e.g., cationic softener Conc. Flakes, which has a solids content of approximately 90% and is available commercially from Th. Goldschmidt AG), stearic ethanolamide, sold under the trade designation Lubesize K-12 (Alpha/Owens Corning), and a polyethyleneimine polyamide salt commercially available at 50% active solid from Cognis under the trade name Emery 6760.

Further, the second precursor size composition may include at least one a wetting agent. Wetting agents function as agents capable of reducing the surface tension of the size composition to facilitate the wetting of the reinforcing fiber material. In addition, wetting agents facilitate contact between the size composition and the fiber surface. Any conventional wetting agent that is compatible with the other ingredients of the size composition may be used. In one preferred embodiment, the wetting agent is a fluoroalkyl alcohol substituted polyethylene glycol marketed under the trade name of Zonyl FS-300 by Dupont. Other suitable wetting agents include non-ionic surfactant wetting agents based on propylene oxide-ethylene oxide block copolymers. A particularly suitable wetting agent is a block copolymer trifunctional polypropylene oxide-polyethylene oxide terminated by secondary hydroxy groups which is commercially available under the trade name Pluronic 10R5 from BASF. The wetting agent may be present in an amount sufficient to achieve an LOI from 0 to 0.027% and most preferably in an amount sufficient to achieve an LOI from about 0.0008% to about 0.0014%.

Although the second precursor size composition is effective at any pH level, the pH preferably falls within the range of from 7 to 10. The pH may be adjusted depending on the intended application, or to facilitate the compatibility of the ingredients of the size composition. Any suitable pH adjuster (e.g., a weak organic acid such as acetic acid or a base such as ammonia), may be added to the size composition in an amount sufficient to adjust the pH to a desired level.

The second precursor size composition may be prepared by adding the individual components using any suitable method known to those of skill in the art. In a preferred embodiment, the second size composition may be prepared by dissolving each of the individual components into a premix with agitation. The separate premixes may then be combined with deionized water to form a main mixture and to achieve the appropriate concentration and control the mix of solids. The premixes may be added in any order. If necessary, the pH of the main mixture may be adjusted to a desired level. The premixes may be added separately, or they may be added at the same time to form the main mixture.

As described above, the two-part sizing composition also includes a binder composition. The binder composition includes at least one blocked isocyanate (e.g, a crosslinking agent) and a copolymer of maleic anhydride and at least one other copolymerizable monomer. In addition, the binder composition may include any suitable additive identified by one of skill in the art, such as, for example, adhesive film forming polymers, lubricants, a surfactant or a mixture of surfactants, antistatic agents, crosslinking agents and coupling agents. The total LOI for the binder composition on the reinforcing fiber material is preferably from approximately 0.2 to 1.50%.

As indicated above, the binder composition contains at least one blocked polyisocyanate. As used herein, the term “blocked” is meant to indicate that the isocyanate groups have been reversibly reacted with a compound so that the resultant blocked isocyanate group is stable to active hydrogens at ambient temperature but reactive with active hydrogens in the film-forming polymer at elevated temperatures, for example, at temperatures between 30° C. and 200° C. The polyisocyanate can be fully blocked or partially blocked so that they will not react with the active hydrogens in the melted resin until the strands of chemically treated glass fibers are heated to a temperature sufficient to unblock the blocked isocyanate and cure the copolymer of maleic anhydride and at least one other copolymerizable monomer. Groups suitable for use as the blocker portion of the blocked isocyanate are well-known in the art and include groups such as alcohols, lactams (e.g., caprolactam), oximes, malonic esters, alkyl acetoacetates, triazoles, phenols, amines, and benzyl t-butylamine (BBA). The blocked polyisocyanate has functional groups that are reactive with the hydroxyl groups in the copolymer described below. One or several different blocking groups could be used together. The blocked isocyanate may be present on the fiber in an amount sufficient to provide an LOI from about 0 to about 1.10%, and preferably from about 0.20% to about 0.60%.

Additionally, the binder composition includes a maleic anhydride copolymer. The term “maleic anhydride copolymer” as used herein includes the pure copolymer as well as derivatives in the anhydride, acid, salt (e.g., (partial) ammonium salt), hemi-ester, or partial-imide form. As used in conjunction with the present invention, the term “partial salt” refers to maleic anhydride monomers having two carboxy groups where one carboxy group is in the free acid form and one carboxy group is converted to a salt. The copolymer may be formed from the polymerization of the maleic anhydride or acid with at least one co-polymerizable co-monomer. The copolymer may also include terpolymers that have at least one maleic anhydride residue. Non-limiting examples of suitable copolymers include C₂-C₅ α-olefins, such as butadiene, ethylene, propylene, methyl vinyl ether, or maleic acid or (iso)butylene-maleic acid copolymers, methyl vinyl ether-maleic acid copolymers, and ethylene-ethylacrylate-maleic anhydride copolymers (E-EA-MAH sold under the trade designation M109D, M220E and M410V by Sumitomo Seika). The maleic anhydride copolymer that is formed is generally in the form of a white or colorless powder. In at least one exemplary embodiment, the copolymer is an aqueous solution of the polyacid, (partial) ammonium salt, half-ester or half-amide derivative of an alternating block copolymer of maleic anhydride, or mixtures thereof. Mixtures of different maleic anhydride copolymers such as those described above may used in the binder composition to achieve desired properties, such as improved fiber dispersion in the melted resin, reduced discoloration in the reinforced fiber product, or improved strand integrity. The maleic anhydride copolymer is present on the fiber in an amount sufficient to provide an LOI from about 0 to about 0.23%, and preferably from about 0.10% to about 0.18%.

The maleic anhydride copolymer is useful for making a clear, transparent, substantially colorless product when used in the binder composition. The copolymer is poorly soluble when dispersed in water at room temperature, but when heated to temperatures above 90° C., it dissolves by virtue of the hydrolysis of the anhydride groups of the polymer to form the corresponding polyacids. In such a reaction, one mole of anhydride is hydrolyzed to two moles of diacid in an exothermic reaction. The aqueous solution formed by the hydrolysis may then be used to formulate the binder composition. Similar reactions may be employed using ammonia or an amine in water, or an alcohol or an amine in a non-reactive solvent, to form, respectively, solutions of the (partial) ammonium salt, half-ester or half-amide derivatives.

In a preferred embodiment, the binder composition includes a partial ammonium salt of ethylene-maleic acid (EMA) copolymer (e.g., a compound having a polyethylene polymer backbone with pendant polyfunctional groups, each of which contains one or more ammonium salt groups) formed by the hydrolysis of an ethylene-maleic anhydride copolymer. The ethylene-maleic anhydride copolymer may be formed by the radical copolymerization between ethylene and maleic anhydride in the presence of a peroxide catalyst. This copolymerization leads to an alternating copolymer that includes a high level of maleic units which gives the ethylene-maleic acid copolymer a high polyacid functionality.

The total LOI for the two-part sizing formulation on the reinforcing fiber material may be from about 0.30% to about 1.50%, preferably from about 0.30% to about 0.90%.

One advantage of the two-part sizing formulation of the present invention is that it imparts improved physical properties to composites formed from pellets, such as improved strength under hydrolysis conditions, improved tensile strength, improved tensile elongation at break, and improved Charpy impact strength. The two-part sizing composition also permits better fiber integrity and a reduction in fraying of the fiber pellets during handling.

Further, the two-part sizing formulation of the present invention has improved stability over conventional sizing formulations containing an aminosilane and a polyacid in the same mixture. Mixtures containing both aminosilanes and polyacids may not be stable due to chemical interactions between the two compounds. By placing substantially all (if not all) of the aminosilane in the size composition and the polyacid in the binder composition, both the size composition and the binder composition have increased shelf lives.

An additional advantage of the two-part sizing composition is that by applying the precursor size composition to the reinforcing fiber material prior to the binder composition, a layer of silane is applied directly and substantially evenly to the reinforcing fiber material. Optimal physical properties of the composite product formed from the sized reinforced fiber materials may be achieved due to the interaction of the silane with the surface of the reinforcing fiber material and the formation of a three-dimensional crosslinked structure of silane on the reinforcing fiber material. In addition, the presence of silane on the reinforcing fiber material reduces subsequent corrosion to the reinforcing fiber materials and abrasion of the individual fibers by avoiding fiber-to-fiber contact.

Another advantage of the two-part sizing composition is that by coating the surface of the reinforcing fiber material with the silane coupling agent by adding the size composition before the binder composition, there is a greater chance that the silane will react with the reinforcing fiber material and not the acid functions of the maleic anhydride copolymer. Thus, coating the reinforcing fiber material with a first layer of silane may lead to higher mechanical properties by lowering the sensitivity of the reinforcing fiber material to additives which are known to reduce the mechanical properties of the composite, e.g., calcium stearate. Although not wishing to be bound by theory, it is believed that when polyacids are added at the same time as the coupling agent, the polyacids interact with the glass surface, leading to a bonded glass surface-matrix that is more sensitive to the presence of metal ions in the matrix (such as when calcium stearate is added to a polyamide matrix).

The present invention is also advantageous in that the polyurethane film former present in the two-part sizing formulation demonstrate good compatibility with polymer matrices containing metal salts. It is well-known that calcium stearate and similar metal salts are useful in improving the de-molding of complex, molded articles, particularly in the instance where polyamide is used as the polymer matrix because polyamide demonstrates an increased affinity for the metal surface.

It is a further advantage of the present invention that the precursor size compositions and the process of the present invention facilitate treating reinforcement fibers, for example glass, during a continuous process that includes forming the fibers as well as subsequent processing or handling. Using the precursor size compositions and binder composition of the present invention allows the fibers to be treated, directly after forming, with sizing components that may not otherwise normally be included in the fiber forming process. Moreover, while the invention is highly suitable for an in-line manufacturing process such as described below, it may also be used in an off-line process in which the precursor size composition and binder size are applied to previously formed and packaged reinforcing fiber materials, or in which the precursor size composition and the binder composition are applied to the reinforcing fiber material at different times. For example, the precursor size composition may be applied to a formed fiber strand, after which the strand may be wound and stored before the subsequent unwinding, chopping into segments, and applying the binder composition.

The process for making a densified reinforcing fiber product may be an in-line process that permits the application of the size composition, the chopping of the glass fibers, the application of the binder composition, and pelletizing the reinforcing fiber material. Such an in-line process forms a pellet product that exhibits superior physical properties, such as improved strength, when integrated into a composite (e.g., when compared to pellets produced by processes previously known in the art). Although not wishing to be bound by theory, such superior properties are believed to be due to the improved compatibility of the size composition and binder composition, which permits a better coating of the reinforcing fiber material.

The process for making a densified reinforcing fiber product according to the invention may employ an apparatus that includes: (a) an apparatus for applying a size composition to a continuous fiber material; (b) an apparatus for cutting the glass fiber strands to form chopped strand segments; (c) an apparatus for conveying the chopped strand segments to a first tumbling apparatus; (d) an apparatus for applying a binder composition to the chopped strand segments; (e) a first tumbling apparatus for imparting a tumbling action to the chopped strand segments to disperse the binder composition and cause the chopped strand segments to align and coalesce into pellets; (f) optionally, an apparatus for conveying the pellets to a second tumbling apparatus; (g) optionally, a second tumbling apparatus for tumbling the pellets to compact them and increase their density; (h) an apparatus for conveying the densified pellets to a drying apparatus; and (i) a drying apparatus adapted to receive and dry the pellets.

Initially, the size composition may be applied to the reinforcing fiber material by any conventional means, including kiss roll, dip-draw, and slide or spray applicators. Preferably, the precursor size is applied by passing the reinforcing fiber material, e.g., strands of glass or polymer, over a kiss roll applicator. The size composition is preferably applied to the strands in an amount sufficient to provide the strands with a moisture content of from about 8% by weight to about 13% by weight, more preferably about 10% to about 11% by weight.

The sized strands may then be chopped into strand segments. The strand segments may have a length of from approximately 2 mm to approximately 50 mm. Preferably, the strands have a length of from about 3 to about 4 mm. Any suitable method or apparatus known to those of ordinary skill for chopping glass fiber strands into segments may be used.

Next, the binder composition may be applied to the chopped strand segments. The coated chopped strand segments are then pelletized by any suitable method known to those of ordinary skill in the art, such as, for example, tumbling or otherwise agitating the chopped strand segments in a pelletizer. Processes suitable for pelletizing the chopped strand segments are disclosed in U.S. Pat. Nos. 5,868,982, 5,945,134, 6,365,090, and 6,659,756 to Strait et al., and U.S. Pat. No. 5,693,378 to Hill et al., all of which are incorporated by reference in their entireties. The amount of moisture in the binder composition serves to adjust the moisture content of the strand segments to a level suitable for the formation of pellets when the strand segments are tumbled in the pelletizer. Although the moisture content of the strand segments can be adjusted prior to their introduction into the pelletizer, it is preferred that the segments are hydrated to a moisture content suitable for pellet formation in the pelletizer itself.

Preferably, the moisture content of the chopped strand segments in the pelletizer is from about 12% by weight to about 16% by weight, and more preferably from about 13% by weight to about 14% by weight, based on the total weight of the binder-sized, chopped strand segments. If the moisture content is too low, the strand segments tend not to combine into pellets and will remain in a strand formation. On the other hand, if the moisture content is too high, the strands tend to agglomerate or clump or form pellets having a large diameter and an irregular, non-cylindrical shape.

The binder composition may be applied to the chopped strand segments as they enter the pelletizer, or after the chopped segments are placed in the pelletizer but prior to tumbling. In an alternative embodiment, the binder composition may be sprayed onto the strands before they are chopped. In this alternative embodiment, it is preferable to use a pelletizer that is specially equipped with tumbling means such as baffles to ensure adequate tumbling and formation of the pellets.

To ensure good coverage of the chopped segments, the binder composition is preferably applied to the chopped strand segments as they enter the pelletizer but before they begin to coalesce into pellets. If the binder composition is applied at other locations within the pelletizer, pellets may form before the strand segments are completely coated with the binder composition, which results in pellets containing fibers that are not coated with the binder composition. When such pellets are used in the manufacture of fiber reinforced composite articles, the uncoated fibers lack the interfacial coating required to provide good reinforcing characteristics, and the resulting composite article will have less than optimal properties. Preferably, the pelletizer is equipped with a spray nozzle, located adjacent to the strand segment inlet, for spraying the binder size onto the strand segments as they enter the pelletizer.

The pelletizer may be any apparatus capable of tumbling the strand segments in such a way that: (1) they become substantially uniformly coated with the binder composition, and (2) multiple chopped strand segments align and coalesce into pellets having a desired dimension. Such a tumbling apparatus should have an average residence time sufficient to insure that the strand segments become substantially coated with the binder size and form pellets, but insufficient for the pellets to be damaged or degraded through abrasion (e.g., by rubbing against one another). Preferably, the residence time in the tumbling apparatus is from about 1 minute to about 10 minutes. More preferably, the residence time in the tumbling apparatus is from about 1 minute to about 3 minutes.

A preferred pelletizer is a rotating drum, such as that disclosed in U.S. Pat. No. 5,868,982, as referenced herein above. U.S. Pat. No. 5,868,982 discloses an apparatus for making reinforcing fiber pellets, which is preferably provided with a system for monitoring and/or adjusting various process parameters. The moisture content of the strand segment input may be monitored and controlled using suitable method. In one embodiment in which the binder composition is applied to the strand segments before they are placed in the pelletizer, the rotating drum is adapted to accommodate a spray head for applying the binder composition to the strand segments as they enter the drum. The binder composition and a solvent, such as water, may be combined into one fluid stream and dispersed through the nozzle orifice. This stream may be combined with two jets of air positioned approximately 180 degrees apart and at an angle of 60 degrees to the direction of the stream flow. Mixing the binder composition with the forced air streams effectively creates a mist that is propelled onto the surface of the tumbling strand segments in the drum.

Rotation of the drum causes the wet strand segments to tumble around one another while the surface tension created by the wet sizing or coating causes strand segments contacting one another over a substantial portion of their length to align with one another and coalesce into a cylindrically shaped pellet. By such action, any fines or single fibers created during the chopping operation are recombined with and incorporated into the forming pellets to essentially eliminate individual fine fibers from the resulting pellets. Preferably, the drum is tilted slightly so that the end of the drum from which the pellets exit is lower than the end in which they enter to ensure that the pellets formed in the drum do not remain in the drum for an excessive period of time.

The size of the pellets formed in the drum is controlled primarily by the moisture content of the strand segments. If the moisture content is maintained at a high level, a greater number of strand segments will coalesce into a pellet and the pellet will have a larger diameter. On the other hand, if the moisture is maintained at a lower level, fewer strand segments will coalesce into a pellet and the pellet will have a smaller diameter. The amount of binder composition that is discharged onto the strands may be controlled by a computer which monitors the weight of wet glass entering the pelletizer and adjusts the amount of the binder composition to obtain a final chopped strand having a strand solids content of from about 0.25% to about 2.05%.

Preferably the pellets formed have a diameter of from about 20% to about 65% of their length. Such pellets are typically formed by combining from about 70 strand segments to about 175 strand segments, each containing from about 500 individual filaments per strand to about 8000 individual filaments per strand.

The size of the pellets may also be affected by drum throughput. For example, the higher the drum throughput, the shorter the residence time of the strand segments in the drum. As a result, smaller pellets may be formed because the binder composition is not adequately dispersed on the strands which may cause the strands not to coalesce into a pellet. In addition, pellets that are formed in the drum for a shorter period of time are less compacted than those pellets that formed in the drum for a longer period of time.

Although some compaction of the formed pellets invariably occurs in the pelletizer, it is typically insufficient to increase the pellet density to a level providing optimum flowability. For this reason, after their formation in the pelletizer, the pellets may optionally be fed into a second tumbling apparatus or densifier, wherein the pellets are further compacted and densified. Any low-impact tumbling apparatus that will compact the pellets without degrading them through abrasion or otherwise damaging the pellets may be used. Preferably, the densifier is a zig-zag tube adapted to be rotated about its longitudinal axis, such as is described in U.S. Pat. Nos. 5,868,982, 5,945,134, 6,365,090, and 6,659,756 to Strait et al.

Preferably, the densifier has a gentler, less vigorous tumbling action than that of the pelletizer to minimize degradation of the pellets. As the zig-zag tube is rotated, pellets placed therein are gently tumbled about by the tube's rotation as they are pulled through the tube by gravity. As with the rotating drum described above, the zig-zag tube densifier is preferably tilted at a slight angle to ensure that the pellets flow through the apparatus without excessive residence times. Furthermore, the densifier preferably has an average residence time of less than approximately 5 minutes to reduce any abrasion that may occur. Preferably, the average residence time in the densifier is from about 1 minute to about 2 minutes.

Although pellet formation and densification may occur in separate apparatuses, such as a separate rotary drum and a rotating zig-zag tube linked by a conveyor, the pelletizing process may be accomplished using any suitable apparatus. For example, pellet formation and densification may occur in separate tumbling regions or zones within a single apparatus. A preferred example of such an apparatus is a “Zig-Zag” blender commercially available from Patterson Kelly. In a preferred embodiment of this device, a drum is equipped with an interior baffle to reduce the free-fall distance of the glass pellets and strand segments during rotation of the drum. By reducing this distance, less deterioration of the glass fibers and pellets through impact and abrasion occurs, resulting in improved physical properties in the glass fiber reinforced molded articles manufactured therefrom.

After densification, the pellets may be delivered onto a conveyor belt and dried, e.g., using a hooded oven supplied with hot air and cooling air or any other suitable drying apparatus easily identified by one of skill in the art. To reduce drying time to a level acceptable for commercial mass production, it is preferred that the fibers are dried at elevated temperatures of up to approximately 260° C. in a fluidized-bed oven, such as a Carman or a Carrier fluidized bed oven. Although a fluidized bed is preferred, any drying oven known to those of skill in the art may be utilized in the present invention. After drying, the densified pellets may be classified by size using a screen or other suitable device.

By varying the throughput and moisture content of the strand segments, glass fiber pellets can be made that are from about 13% to about 60% denser than the corresponding unpelleted strand segments, and from about 10 times to about 65 times larger in diameter. For example, chopped 4 mm (length) segments of a 2000 filament strand composed of 14 micron (diameter) fibers typically have a bulk density of from about 33 lb/ft³ (528.66 kg/m³) to 36 lb/ft³ (576.72 kg/m³). After being hydrated to a moisture content of from about 13% to about 14% and formed into densified pellets such as is described above, according to the process of the invention, the resulting dried pellets typically have a bulk density of from about 40 lb/ft³ (640.8 kg/m³) to about 55 lb/ft³ (881.1 kg/m³). As a result of their increased diameter-to-length ratio and increased density, the resulting pellets exhibit significantly improved flowability in comparison to the unpelleted chopped strand product.

In an alternative embodiment described in detail in U.S. Ser. No. 11/319,889 filed Dec. 28, 2005 and incorporated by reference in its entirety, the coated chopped strand segments are introduced into a drum having a plurality of scoops positioned on the interior side wall. The drum is rotated about its longitudinal axis such that a supply of the chopped glass segments are raised by the scoops and then allowed to cascade from the scoop during the drum's rotation. At each of these numerous cascading cycles, the granules capture on their surface droplets of the atomized binder composition. The chopped strand segments are agglomerated into a granule. The granule grows according to an “onion layer” building process. The cascading, tumbling, and rolling action imparted to the granules causes the agglomerated strand segments to align and compact themselves into a desired granule configuration (e.g., a pellet).

The size composition and the binder composition facilitate treating reinforcing fiber materials, e.g., glass, during a continuous process that includes forming the fibers as well as subsequent processing or handling. By applying the binder composition in the pelletizer, an application efficiency of about 95% to about 100% for the binder composition may be obtained. This high application efficiency reduces waste water contamination in the plant. Further, because the binder composition can be applied efficiently, the binder composition may be applied with a reduction in cost.

In addition, by applying the binder composition separately from the sizing composition outside the fiber-forming environment permits, materials that are not desirably applied during the fiber-forming process because of toxicity, safety, flammability, irritation, stability, low compatibility with aminosilanes, viscosity, toxicity, cleanliness, odor, cost, or shear sensitivity may be applied to the glass fibers. Also, because the polyacid in the binder composition can be applied to the glass fibers in a more concentrated form in the pelletizer than if it were applied directly to the glass strands as they are being formed, there is reduced fiber logging and waste as compared to conventional in-line processes.

Although the invention is highly suitable for in-line manufacturing processes, such as described above, it may also be used in an off-line process in which the size composition and the binder composition are applied to previously formed and packaged reinforcing fiber materials, or in which the size composition and the binder composition are applied to the reinforcing fiber material at different times. For example, the size composition may be applied to a formed fiber strand, after which the strand may be wound and stored before subsequent unwinding, chopping into segments and application of the binder composition.

Having generally described this invention, a further understanding can be obtained by reference to certain specific examples illustrated below which are provided for purposes of illustration only and are not intended to be all inclusive or limiting unless otherwise specified.

### EXAMPLES

### Example 1

### Inventive Two-Part Sizing Composition

The size composition as set forth in Table 3 was prepared and applied to Advantex® glass fibers as they were produced in a continuous in-line process. In particular, the aqueous size composition was applied with a conventional kiss roll type applicator. The size composition was applied to achieve a strand total Loss-On-Ignition (LOI) of 0.22% solid on the glass fibers. A conventional loss on ignition (LOI) method, ASTM 2854, was used to determine how much of the applied chemical treatment was on the glass fibers. The glass fibers were then collected into a strand and chopped in-line by a chopper into segments.

TABLE 3
Precursor Size Composition

| Component | % Active Solids | % LOI |
|---|---|---|
| Coupling Agent | 58.0 | 0.0622 |
| Polyurethane Film Forming Agent | 34.5 | 0.1576 |

The chopped segments were then conveyed to a pelletizer where the inventive binder according to Table 4 was sprayed onto the chopped segments as they passed through the entrance chamber of the pelletizer. The binder composition was applied to achieve a strand total LOI of 0.610% on the glass fibers. The total Loss-On-Ignition (LOI) of the glass was 0.830%. The densified glass pellets were then conveyed to a fluidized bed oven and dried to a moisture content of less than or equal to approximately 0.05%.

TABLE 4
Binder Composition

| Component | % Active Solids | % LOI |
|---|---|---|
| Blocked Isocyanate | 31.0 | 0.4605 |
| Ethylene Maleic Anhydride Copolymer | 34.5 | 0.1495 |

### Example 2

### Alternative Inventive Two-Part Sizing Composition

The size composition as set forth in Table 5 was prepared and applied to Advantex® glass fibers as they were produced in a continuous in-line process. In particular, the aqueous size composition was applied with a conventional kiss roll type applicator. The size composition was applied to achieve a strand total Loss-On-Ignition (LOI) of 0.0600% solid on the glass fibers. A conventional loss on ignition (LOI) method, ASTM 2854, was used to determine how much of the applied chemical treatment was on the glass fibers. The glass fibers were then collected into a strand and chopped in-line by a chopper into segments.

TABLE 5
Precursor Size Composition

| Component | % Active Solids | % LOI |
|---|---|---|
| Coupling Agent | 58.0 | 0.0549 |
| Lubricant | 88.9 | 0.0039 |
| Wetting Agent | 0.400 | 0.0012 |

The chopped segments were then conveyed to a pelletizer where the inventive binder according to Table 6 was sprayed onto the chopped segments as they passed through the entrance chamber of the pelletizer. The binder composition was applied to achieve a strand total LOI of 0.77% on the glass fibers. The total Loss-On-Ignition (LOI) of the glass was 0.83%. The densified glass pellets were then conveyed to a fluidized bed oven and dried.

TABLE 6
Binder Composition

| Component | % Active Solids | % LOI |
|---|---|---|
| Polyurethane | 34.5 | 0.1577 |
| Blocked Isocyanate | 31.0 | 0.4605 |
| Ethylene Maleic Anhydride Copolymer | 34.5 | 0.1495 |

### Example 3

### Mechanical Properties of Black Pigmented and Heat Stabilized Polyamide 66 Reinforced with 30% Glass Fibers Sized with the Inventive Two Part Sizing Formulation

Chopped fiber samples were compounded with polyamide in a twin screw co-rotating, intermeshing screw extruder (ZSK30 (Coperion)) at 350 RPM with a throughput of 20 Kg/hr. The recorded melt temperature for the PA 66 fibers was approximately 315° C. Glass fiber bundles were fed into the extruder via a gravimetric feeder downstream in the melt. The rods were then cooled in a water bath and chopped into pellets. After a re-dry at 95° C. for 12 hours, the glass reinforced pellets were molded in a normalized test specimen with Axxicom molds installed on an Arburg 420C ALLROUNDER 800-250 injection molding press.

The glass reinforced samples were tested for Charpy Impact strength both before and after hydrolyzation in a 50/50 water/ethylene glycol mix for 504 hours at 130° C. The Charpy impact was measured according to the testing procedures set forth in ISO179/1eU. The results for the dry-as-molded Charpy Impact strength tests are shown in Table 7.

TABLE 7
Charpy Impact Strength (Dry-As-Molded)

| Sizing | | Glass | Number of | Mean | Standard |
|---|---|---|---|---|---|
| Composition | LOI | Content (%) | Trials | (KJ/m²) | Deviation |
| A | | 29.79 | 20 | 90.317 | 8.054 |
| B | | 29.45 | 20 | 91.851 | 7.610 |
| INV-1 | 0.90 | 29.74 | 20 | 92.579 | 5.683 |
| C | | 29.80 | 20 | 91.893 | 4.659 |
| INV-2 | 0.75 | 30.05 | 20 | 95.682 | 5.451 |
| D | | 29.48 | 20 | 92.440 | 7.612 |
| E | | 29.41 | 20 | 91.678 | 6.117 |

Samples A, B, and E were commercial sizing formulations from Owens Coming and were used in the Examples as comparative examples. The inventive two part sizing formulations used in the Examples are indicated by INV-1 and INV-2. A 0.90% LOI and a 0.75 LOI of the inventive sizing formulation were tested. C and D were the closest sizing formulations marketed by competitors. It can be seen in Table 7 that the samples of the inventive sizing formulations demonstrated the highest dry-as-molded Charpy impact strength of all the tested size formulations.

Table 8 depicts the Charpy impact strengths of the various samples after 504 hours of hydrolysis in a 50/50 water/ethylene glycol mix at 130° C.

TABLE 8
Charpy Impact Strength (After Hydrolysis)

| Sizing | | Number of | Mean | Standard |
|---|---|---|---|---|
| Composition | LOI | Trials | (KJ/m²) | Deviation |
| A | | 8 | 39.815 | 4.563 |
| B | | 8 | 42.132 | 4.912 |
| INV-1 | 0.90 | 8 | 41.784 | 4.445 |
| C | | 8 | 41.821 | 6.350 |
| INV-2 | 0.75 | 8 | 43.196 | 7.540 |
| D | | 8 | 40.553 | 3.890 |
| E | | 8 | 41.747 | 6.209 |

As shown in Table 8, after hydrolyzation, the 0.75% LOI inventive size formulation (INV-2) demonstrated the highest impact strength at 43.196 KJ/m². However, it can be seen that the tested sizes had similar strengths clustered around 42 KJ/m². It is to be appreciated that sizes A, B, C, and E, although they may possess adequate Charpy impact strength and hydrolysis resistance, they do not have the superior fiber dispersion possessed by the inventive two part size formulation (shown in Example 5). The good fiber dispersion caused at least in part by the inventive size formulation reduces visual defects, processing breaks, and eases the processing of the polymer matrix. In addition, the good dispersion qualities of the two part sizing formulation facilitate the incorporation of the fiber bundles in the polyamide, which is useful with twin screw extruders that have increased throughput and reduced residence time.

The tensile strengths of the various size formulations were tested according to the procedures set forth in ISO527-1a. The tensile strengths before and after hydrolyzation in a 50/50 water/ethylene glycol mix for 504 hours at 130° C. are shown in Tables 9 and 10 respectively.

TABLE 9
Tensile Strength (Dry-As-Molded)

| Sizing | | Number of | Mean | Standard |
|---|---|---|---|---|
| Composition | LOI | Trials | (MPa) | Deviation |
| A | | 9 | 204.944 | 0.425 |
| B | | 10 | 204.620 | 0.193 |
| INV-1 | 0.90 | 9 | 201.733 | 0.194 |
| C | | 10 | 202.090 | 0.338 |
| INV-2 | 0.75 | 10 | 201.180 | 1.351 |
| D | | 10 | 209.660 | 1.034 |
| E | | 10 | 202.620 | 0.516 |

TABLE 10
Tensile Strength (After Hydrolysis)

| Sizing | | Number of | Mean | Standard |
|---|---|---|---|---|
| Composition | LOI | Trials | (MPa) | Deviation |
| A | | 5 | 69.040 | 2.068 |
| B | | 5 | 70.020 | 3.914 |
| INV-1 | 0.90 | 5 | 71.120 | 2.013 |
| C | | 5 | 70.600 | 1.502 |
| INV-2 | 0.75 | 5 | 70.400 | 1.437 |
| D | | 5 | 71.020 | 1.973 |
| E | | 5 | 68.120 | 2.928 |

With respect to the dry-as molded tensile strengths shown in Table 9, only sample D showed a significantly high tensile strength of 209.660 MPa. The remainder of the tested formulations demonstrated similar tensile strengths between about 201.0 and 204.0 MPa. While the inventive size formulations did not possess the highest dry-as-molded tensile strengths of the sizes tested, they did possess adequate tensile strengths for commercial use. After hydrolysis, it can be sent that the tested sizes were not significantly different from each other and ranged in tensile strength from 68.120 MPa to 71.120 MPa (see, Table 10). As discussed above, size formulations A, B, D, and E do not have the improved dispersion qualities of the inventive size formulations. As shown below in Example 5, the inventive size formulations demonstrated good tensile strength and an excellent dispersion in the polyamide matrix. Therefore, the inventive two part size formulations are more desirable than the other tested samples from a commercial standpoint, both in view of the Charpy impact and tensile strengths and the good dispersion qualities.

Tables 11 and 12 illustrate the tensile elongation at break before and after hydrolyzation in a 50/50 water/ethylene glycol mix for 504 hours at 130° C. respectively.

TABLE 11
Tensile Elongation At Break (Dry-As-Molded)

| Sizing | | Number of | | Standard |
|---|---|---|---|---|
| Composition | LOI | Trials | Mean (%) | Deviation |
| A | | 9 | 3.8256 | 0.1076 |
| B | | 10 | 3.8900 | 0.0852 |
| INV-1 | 0.90 | 10 | 4.0110 | 0.0612 |
| C | | 10 | 3.7410 | 0.1035 |
| INV-2 | 0.75 | 10 | 3.9640 | 0.1596 |
| D | | 10 | 3.8870 | 0.1715 |
| E | | 10 | 3.8930 | 0.0772 |

TABLE 12
Tensile Elongation At Break (After Hydrolysis)

| Sizing | | Number of | | Standard |
|---|---|---|---|---|
| Composition | LOI | Trials | Mean (%) | Deviation |
| A | | 5 | 2.4400 | 0.1255 |
| B | | 5 | 2.6280 | 0.3242 |
| INV-1 | 0.90 | 5 | 2.7040 | 0.1521 |
| C | | 5 | 2.6920 | 0.0981 |
| INV-2 | 0.75 | 5 | 2.5960 | 0.0945 |
| D | | 5 | 2.4720 | 0.1207 |
| E | | 5 | 2.4340 | 0.2105 |

A high tensile elongation at break is an important feature of the sized glass fibers in order for the fibers to possess adequate strength in the final article. It is to be appreciated that the tensile elongation at break for the same tensile strength and module results in a greater surface area under the tensile curve. This greater surface area indicates that more energy is required to break the molded article. Thus, the tensile elongation at break roughly correlates to Charpy impact strength. If the tensile elongation at break is high, it may be presumed that the Charpy impact strength is also high. Testing the tensile elongation at break is an additional testing method to consolidate the results of the Charpy impact strength of the tested size composition. It can be seen in Tables 11 and 12 that sample INV-2 (inventive size formulation at 0.75% LOI) demonstrated a high tensile elongation at break before and after hydrolysis. This test confirmed that INV-2 has a good Charpy impact strength.

### Example 4

### Mechanical Properties of Polyamide 66 Fibers (Zytel E101LN10 from DuPont) Reinforced with 30% Glass Fibers Sized with the Two Part Sizing Formulation

After compounding and injection molding as described above in Example 3, the sized fibers were tested for Charpy impact strength both before and after hydrolyzation in a 50/50 water/ethylene glycol mix for 250 hours at 135° C. As in the prior example, A, B, and E were commercial sizing formulations from Owens Corning and were used as comparative examples. The inventive two part sizing formulations are indicated by INV-1 and INV-2. As in Example 3, a 0.90% LOI and a 0.75 LOI of the inventive size formulations were tested. Samples C and D were the closest sizing formulations marketed by competitors.

The Charpy impact strengths of the various samples in a dry-as-molded state are depicted in Table 13.

TABLE 13
Charpy Impact Strength (Dry-As-Molded)

| Sizing | | Glass | Number | Mean | Standard |
|---|---|---|---|---|---|
| Composition | LOI | Content (%) | of Trials | (KJ/m²) | Deviation |
| A | | 29.80 | 20 | 73.803 | 5.608 |
| B | | 29.72 | 19 | 74.255 | 4.433 |
| INV-1 | 0.90 | 29.78 | 19 | 77.423 | 5.831 |
| C | | 30.06 | 20 | 70.609 | 6.769 |
| INV-2 | 0.75 | 29.63 | 18 | 74.569 | 7.051 |
| D | | 29.67 | 20 | 75.180 | 7.075 |
| E | | 29.68 | 20 | 71.425 | 6.631 |

TABLE 14
Charpy Impact Strength (After Hydrolysis)

| Sizing | | Number of | Mean | Standard |
|---|---|---|---|---|
| Composition | LOI | Trials | (KJ/m²) | Deviation |
| A | | 10 | 81.483 | 3.153 |
| B | | 9 | 84.578 | 3.297 |
| INV-1 | 0.90 | 10 | 79.035 | 3.328 |
| C | | 10 | 67.495 | 3.004 |
| INV-2 | 0.75 | 10 | 77.291 | 2.245 |
| D | | 10 | 73.990 | 2.797 |
| E | | 10 | 77.303 | 3.015 |

The 0.90% LOI inventive sizing formulation demonstrated the highest dry-as-molded Charpy impact strength of all the tested sizes (see, Table 13). As shown in Table 14, after hydrolyzation, the 0.90% LOI inventive size formulation demonstrated the highest Charpy impact strength. It is to be appreciated that although sizes A, B, D, and E may possess adequate Charpy impact strength and hydrolysis resistance for commercial use, they do not demonstrate the superior fiber dispersion qualities of the inventive size formulations. In addition, it to be noted that even if sample C presented an equivalent dispersion with the two part sizing of present invention, sample C possesses lower Charpy impact strengths in the polyamide compared to the inventive formulation both in the dry-as-molded state and after hydrolysis.

As with the previous example, the tensile strengths before and after hydrolyzation were tested. The hydrolyzation occurred in a 50/50 water/ethylene glycol mix for 250 hours at 135° C. The results are shown in Tables 15 and 16 respectively.

TABLE 15
Tensile Strength (Dry-As-Molded)

| Sizing | | Number of | Mean | Standard |
|---|---|---|---|---|
| Composition | LOI | Trials | (MPa) | Deviation |
| A | | 10 | 199.990 | 0.498 |
| B | | 10 | 203.160 | 0.438 |
| INV-1 | 0.90 | 10 | 202.750 | 0.566 |
| C | | 10 | 199.720 | 0.836 |
| INV-2 | 0.75 | 10 | 197.880 | 1.229 |
| D | | 10 | 201.740 | 0.785 |
| E | | 10 | 200.520 | 0.349 |

TABLE 16
Tensile Strength (After Hydrolysis)

| Sizing | | Number of | Mean | Standard |
|---|---|---|---|---|
| Composition | LOI | Trials | (MPa) | Deviation |
| A | | 5 | 89.080 | 0.342 |
| B | | 5 | 92.180 | 0.110 |
| INV-1 | 0.90 | 5 | 90.060 | 0.451 |
| C | | 5 | 80.880 | 0.432 |
| INV-2 | 0.75 | 5 | 88.680 | 0.217 |
| D | | 5 | 85.600 | 0.436 |
| E | | 5 | 89.740 | 0.391 |

With respect to the dry-as molded tensile strengths, INV-1 demonstrated the highest tensile strength of all the tested size formulations. After hydrolysis, the inventive size formulations demonstrated tensile strengths that were greater than the tensile strengths of the competitor's sizes (samples C and D). Therefore, not only do the inventive size formulations demonstrate superior tensile strength after hydrolyzation, as shown in Table 16, but they also possess superior dispersion qualities, as shown below in Example 5. It is desirable to have glass fibers that possess good dispersion so that the fibers can be used without production problems (e.g., pluggage of the injection molding machines) on all of the existing equipment and posses excellent mechanical properties.

In addition, the tensile elongation at break before and after hydrolysis of the samples were tested. Tables 17 and 18 illustrate the tensile elongation at break before and after hydrolysis in a 50/50 water/ethylene glycol mix for 250 hours at 135° C. respectively.

TABLE 17
Tensile Elongation At Break (Dry-As-Molded)

| Sizing | | Number of | | Standard |
|---|---|---|---|---|
| Composition | LOI | Trials | Mean (%) | Deviation |
| A | | 10 | 3.7200 | 0.0976 |
| B | | 10 | 3.7160 | 0.0998 |
| INV-1 | 0.90 | 10 | 3.6880 | 0.1778 |
| C | | 10 | 3.4920 | 0.1356 |
| INV-2 | 0.75 | 10 | 3.6720 | 0.1429 |
| D | | 10 | 3.5760 | 0.1358 |
| E | | 10 | 3.6090 | 0.1269 |

TABLE 18
Tensile Elongation At Break (After Hydrolysis)

| Sizing | | Number of | | Standard |
|---|---|---|---|---|
| Composition | LOI | Trials | Mean (%) | Deviation |
| A | | 5 | 4.2300 | 0.791 |
| B | | 5 | 4.5680 | 0.0507 |
| INV-1 | 0.90 | 5 | 4.2300 | 0.1538 |
| C | | 5 | 3.5560 | 0.1276 |
| INV-2 | 0.75 | 5 | 4.0860 | 0.1759 |
| D | | 5 | 3.6560 | 0.0688 |
| E | | 5 | 4.2380 | 0.0955 |

As discussed above, tensile elongation at break is an important property of the sized glass and is needed to achieve adequate properties. The inventive size formulations at 0.90% LOI and at 0.75% LOI demonstrate a high tensile elongation at break before hydrolysis (see, Table 17) and after hydrolysis (see, Table 18) than the competitor size formulations. Although samples A and B provided slightly higher tensile elongation in the dry-as-molded experiment and the same or higher tensile elongation at break after hydrolyzation than the inventive size formulations, the inventive size formulations provided superior dispersion properties (see, Example 5). Glass fibers that provide excellent fiber dispersion and high mechanical properties, as is demonstrated by the inventive two part size formulation, are highly desired in the marketplace because such glass fibers are essentially trouble free during compounding and have high composite performance. Glass fibers having such desirable features also bring substantial gains in flexibility and productivity. The high mechanical properties permit more freedom for one of skill in the art to experiment and achieve other desired properties such as pigmentation, flame retardancy, and heat stability.

### Example 5

### Dispersion in Polyamide (PA66 Reinforced With 35% Glass Fibers)

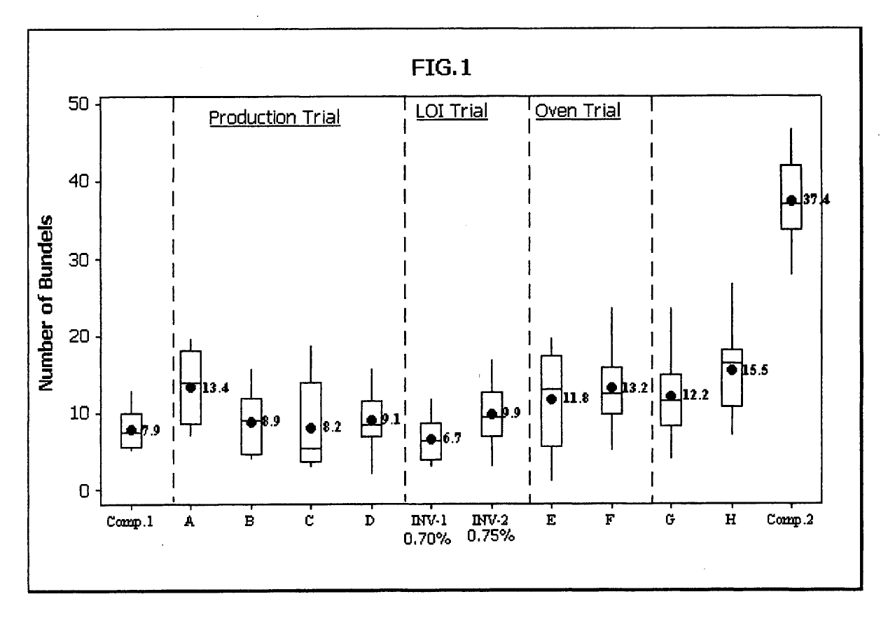

Bundles of fibers sized with the inventive sizing formulation were tested for dispersion in polyamide. A mix of 65% polyamide pellets and 35% glass fiber bundles were dry blended and injected directly in a plate mold having the dimensions of 60 mm×60 mm×2 mm. The undispersed fiber bundles were then counted either by transparency or by x-ray photography (i.e., for pigmented grades). In FIG. 1, the production test samples refer to readings taken at regular intervals during a production run lasting approximately 8 hours. The testing was conducted at optimal standard conditions. The LOI trial refers to the production run at two different LOI (0.70% and 0.75%). The oven trial refers to trials run at the extreme of the operating temperature window of the oven cure temperatures. For comparison purposes, bundles of fibers sized with the competitor size formulations (Comp. 1 and Comp. 2) were tested. As shown in FIG. 1, only a small amount of bundles remained undispersed in the matrix when the fibers were coated with the inventive size formulation. It can be seen from the samples tested that the inventive two part composition yields dispersion qualities comparable to Comp. 1. It can also be seen that Comp. 2 possessed significantly lower dispersion qualities. Thus, it can be concluded that the two part sizing composition of the present invention has improved fiber dispersion compared to Comp. 2.

As discussed previously, it is desirable from a commercial standpoint to have easy fiber dispersion (e.g., few remaining fiber bundles in the polymer matrix). In addition, better fiber dispersion results in a final product that has fewer visual defects and that has high impact and tensile strengths. Further, it is desirable to have easy and fast dispersion of the fiber bundles so that continuous in-line processing can be used. When undispersed bundles exit the extruder, they may plug the die plate and/or cause rod breaks, resulting in a loss in productivity. Additionally, when undispersed or partially dispersed bundles pass through the die, they may cause additional problems downstream. For example, the undispersed bundles may not be cut properly and may cause visual defects in the final product. In addition, if the undispersed fibers make it farther in the manufacturing process, they may plug the thin gate of a critical mold, resulting in additional loss of product and loss of money.

### Example 6

### Calcium Stearate Addition in Increments From 0.01% to 0.5% to PA6 Reinforced with 30% Glass Fibers

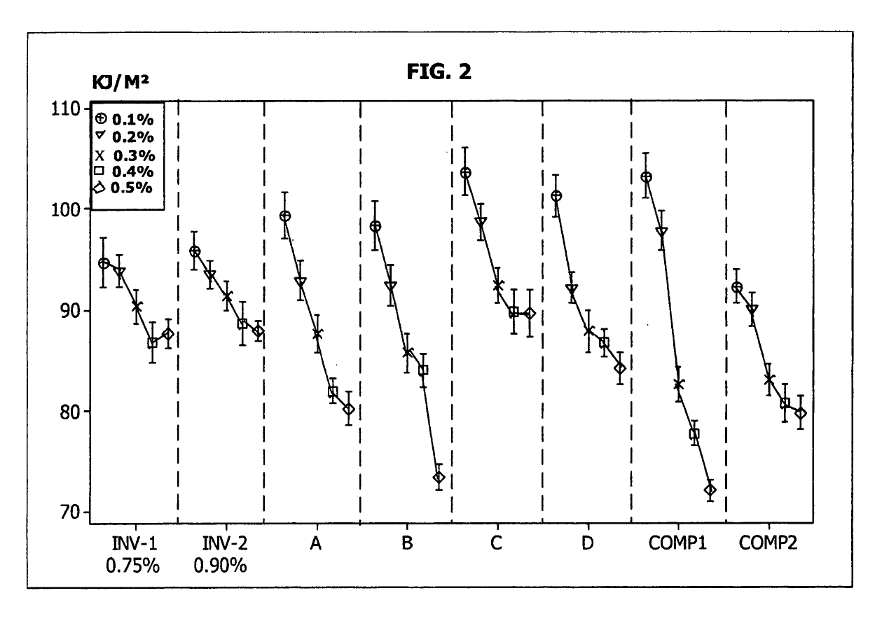

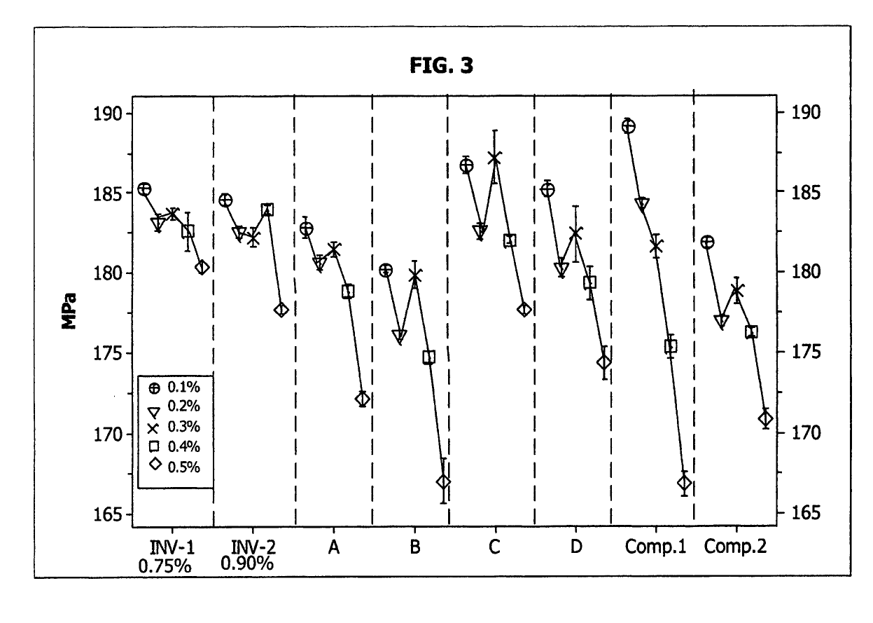

FIG. 2 illustrates the Charpy impact (dry-as-molded) strengths of fibers sized with both the inventive size formulations at 0.75% and 0.90% LOI and comparative size formulations (including competitor size formulations Comp. 1 and Comp. 2). The remaining samples that were tested (samples A-H) were included for comparison purposes. It is clear from FIG. 2 that the inventive size formulations lost only a very small amount of the Charpy impact strength as calcium stearate was incrementally added. On the other hand, as calcium stearate was added to the comparative examples, a large amount of the Charpy impact strength was lost. Similar results were obtained for the dry-as-molded tensile strengths of fibers sized with the inventive size formulations 0.75% and 0.90% LOI and the comparative size formulations. It can be seen in FIG. 3 that only a small amount of tensile strength in the inventive formulations was lost with the addition of calcium stearate, whereas a large amount of tensile strength in the comparative examples was lost with the addition of calcium stearate. This is an important feature of the inventive size formulation because typically the addition of calcium stearate to polyamide containing fibers that have a sizing that is resistant to hydrolysis (e.g., automotive applications such as cooling radiators) has an adverse effect on the Charpy impact and tensile strengths. Because the inventive size formulation loses only a minimal amount of Charpy impact strength, a better, stronger product can be formed without having to modify existing formulations and/or manufacturing equipment. In addition, it is possible with the inventive size formulation to include a larger amount of calcium stearate to enhance the processing and demolding properties without losing a significant amount of the mechanical properties. This ability to include calcium stearate without a great loss in mechanical properties is particularly useful in applications where complex forms with perfect mold-removing is needing to ensure a useful product and to maintain productivity.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A two-part sizing formulation for sizing a reinforcing fiber used to form a composite product comprising:
a size composition including;
one or more silane coupling agents; and
at least one film-forming agent; and
a binder composition including:
at least one blocked isocyanate; and
a copolymer or a derivative thereof, said copolymer being formed from maleic anhydride and at least one other monomer copolymerizable therewith.

2. The two-part sizing formulation of claim 1, wherein said silane coupling agent is an aminosilane coupling agent.

3. The two-part sizing formulation of claim 2, wherein said film forming agent is a polyurethane film forming agent.

4. The two-part sizing formulation of claim 1, wherein said size composition further includes at least one additive selected from pH adjusters, antioxidants, antifoaming agents, processing aids, antistatic agents and non-ionic surfactants.

5. The two-part sizing formulation of claim 1, wherein said coupling agent is applied to said reinforcement fibers in an amount sufficient to achieve a Loss on Ignition from about 0.02% to about 0.40% on said dried reinforcement fiber, said film forming agent is applied in an amount sufficient to achieve a Loss on Ignition from about 0% to about 1.20% on said dried reinforcement fiber, said blocked isocyanate is applied in an amount sufficient to achieve a Loss on Ignition from 0% to about 1.20% on said dried reinforcement fiber, and said copolymer is applied in an amount sufficient to achieve a Loss on Ignition from about 0.20% to about 1.50% on said dried reinforcement fiber.

6. The two-part sizing formulation of claim 1, wherein said copolymer is selected from butadiene, ethylene, propylene, methyl vinyl ether, maleic acid, (iso)butylene-maleic acid copolymers, methyl vinyl ether-maleic acid copolymers and ethylene-ethylacrylate-maleic anhydride copolymers.

7. The two-part sizing formulation of claim 1, wherein said copolymer is selected from the group consisting of a maleic anhydride-butadiene copolymer and a maleic anhydride-butadiene copolymer partial ammonium salt.

8. The two-part sizing formulation of claim 1, wherein said blocked isocyanate is blocked by at least one blocking agent selected from alcohols, lactams, oximes, malonic esters, alkyl acetoacetates, triazoles, phenols, amines and benzyl t-butylamine.

9. The two-part sizing formulation of claim 8, wherein said polyisocyanate is fully blocked or partially blocked so that said polyisocyanate will not react with active hydrogens in the melted resin until glass fibers treated with said two-part formulation are heated to a temperature sufficient to unblock said blocked isocyanate and cure said copolymer.

10. A two-part sizing formulation used to form a composite article comprising:
a size composition including:
one or more coupling agents;
one or more lubricants; and
at least one wetting agent; and
a binder composition including:
at least one blocked isocyanate; and
a copolymer or a derivative thereof, said copolymer being formed from maleic anhydride and at least one other monomer copolymerizable therewith.

11. The two-part sizing formulation of claim 10, wherein said silane coupling agent is an aminosilane coupling agent.

12. The two-part sizing formulation of claim 10, wherein said copolymer is selected from a maleic anhydride-butadiene copolymer and a maleic anhydride-butadiene copolymer partial ammonium salt.

13. The two-part sizing formulation of claim 12, wherein said blocked isocyanate is blocked by a blocking agent selected from alcohols, lactams, oximes, malonic esters, alkyl acetoacetates, triazoles, phenols, amines and benzyl t-butylamine.

14. The two-part sizing formulation of claim 13, wherein said polyisocyanate is fully blocked or partially blocked so that said polyisocyanate will not react with active hydrogens in the melted resin until glass fibers treated with said two-part formulation are heated to a temperature sufficient to unblock the blocked isocyanate and cure said copolymer.

15. The two-part sizing formulation of claim 10, wherein said lubricant is selected from water-soluble ethyleneglycol stearates, ethyleneglycol oleates, ethoxylated fatty amines, glycerine, emulsified mineral oils, organopolysiloxane emulsions alkyl imidazoline derivatives, stearic ethanolamide and polyethyleneimine polyamide salts.

16. The two-part sizing formulation of claim 1, wherein said coupling agent is applied to said reinforcement fibers in an amount sufficient to achieve a Loss on Ignition from about 0.02% to about 0.10% on said dried reinforcement fiber, said lubricant is applied in an amount sufficient to achieve a Loss on Ignition from about 0% to about 0.01% on said dried reinforcement fiber, said wetting agent is applied in an amount sufficient to achieve a Loss on Ignition from about 0% to about 0.027% on said dried reinforcement fiber said blocked isocyanate is applied in an amount sufficient to achieve a Loss on Ignition from 0% to about 1.20% on said dried reinforcement fiber, and said copolymer is applied in an amount sufficient to achieve a Loss on Ignition from about 0.2% to about 1.50% on said dried reinforcement fiber.

17. A reinforced composite article comprising a plurality of reinforcing fiber materials sized with a two-part sizing formulation including:
a size composition including;
at least one silane coupling agent; and
one or more film-forming agents; and
a binder composition including:
at least one blocked isocyanate; and
a copolymer or a derivative thereof, said copolymer being formed from maleic anhydride and at least one other monomer copolymerizable therewith.

18. The reinforced composite article of claim 17, wherein said copolymer is selected from the group consisting of a maleic anhydride-butadiene copolymer and a maleic anhydride-butadiene copolymer partial ammonium salt.

19. The reinforced composite article of claim 17, wherein said blocked isocyanate is blocked by a blocking agent selected from alcohols, lactams, oximes, malonic esters, alkyl acetoacetates, triazoles, phenols, amines and benzyl t-butylamine.

20. The reinforced composite article of claim 19, wherein said polyisocyanate is fully blocked or partially blocked so that said polyisocyanate will not react with active hydrogens in the melted resin until glass fibers treated with said two-part formulation are heated to a temperature sufficient to unblock said blocked isocyanate and cure said copolymer.

21. The reinforced composite article of claim 17, wherein said silane coupling agent is an aminosilane coupling agent and said film forming agent is a polyurethane film forming agent.

22. A reinforced composite article comprising a plurality of reinforcing fiber materials sized with a two-part sizing formulation including:
a size composition including;
one or more coupling agents;
one or more lubricants; and
at least one wetting agent; and
a binder composition including:
at least one blocked isocyanate; and
a copolymer or a derivative thereof, said copolymer being formed from maleic anhydride and at least one other monomer copolymerizable therewith.

23. The reinforced composite article of claim 21, wherein said copolymer is selected from the group consisting of a maleic anhydride-butadiene copolymer and a maleic anhydride-butadiene copolymer partial ammonium salt.

24. The reinforced composite article of claim 21, wherein said blocked isocyanate is blocked by a blocking agent selected from alcohols, lactams, oximes, malonic esters, alkyl acetoacetates, triazoles, phenols, amines and benzyl t-butylamine.

25. The reinforced composite article of claim 21, wherein said polyisocyanate is fully blocked or partially blocked so that said polyisocyanate will not react with active hydrogens in the melted resin until glass fibers treated with said two-part formulation are heated to a temperature sufficient to unblock the blocked isocyanate and cure said copolymer.

26. The reinforced composite article of claim 21, wherein said silane coupling agent is an aminosilane coupling agent.
